(19) United States
(12) Patent Application Publication
(10) Pub. No.: US 2014/0365542 A1
(43) Pub. Date: Dec. 11, 2014

(54) DATA PROCESSING SYSTEM AND METHOD

(71) Applicant: HON HAI PRECISION INDUSTRY CO., LTD., New Taipei (TW)

(72) Inventor: WEI-TE LIN, New Taipei (TW)

(73) Assignee: HON HAI PRECISION INDUSTRY CO., LTD., New Taipei (TW)

(21) Appl. No.: 14/010,542

(22) Filed: Aug. 27, 2013

(30) Foreign Application Priority Data
Jun. 6, 2013 (TW) 102120152

(51) Int. Cl. G06F 17/30

(52) U.S. Cl. CPC G06F 17/30194
USPC 707/827

(57) ABSTRACT

A data processing system and a data processing method for a number of electronic devices are disclosed. All the electronic devices are connected to the same network. When an electronic device performs a task, the system broadcasts a request to other electronic devices, and the request contains an attribute of the electronic device and content relative to the task. The system acquires the attribute of the electronic device and the content associated with the task in response to the request and acquires an attribute of each of other electronic devices and acquires files relative to the content from each of other electronic devices according to the attributes of each of other electronic devices and the electronic device. The system receives the files from each of other electronic devices and acquiring files relative to the content from the electronic device to finish the task.

### BACKGROUND

1. Technical Field

The disclosure relates to data processing technology and, more particularly, to a data processing system and a data processing method adapted for an electronic device.

2. Description of Related Art

When a user makes an album on a computer, the photos, which are stored in the computer and can be utilized to make the album, are finite, thus, the user often searches more photos from the Internet and/or a server to finish the album, which results in wasting time.

Therefore, what is needed is a data processing system to overcome the described shortcoming

### BRIEF DESCRIPTION OF THE DRAWINGS

FIG. 1 is an applied schematic view of a data processing system in accordance with an exemplary embodiment.

FIG. 2 is a block diagram of an electronic device performing the data processing system of FIG. 1.

FIG. 3 is a block diagram of the data processing system of FIG. 1.

FIG. 4 is a flowchart illustrating a method of processing data adapted for the data processing system of FIG. 1.

### DETAILED DESCRIPTION

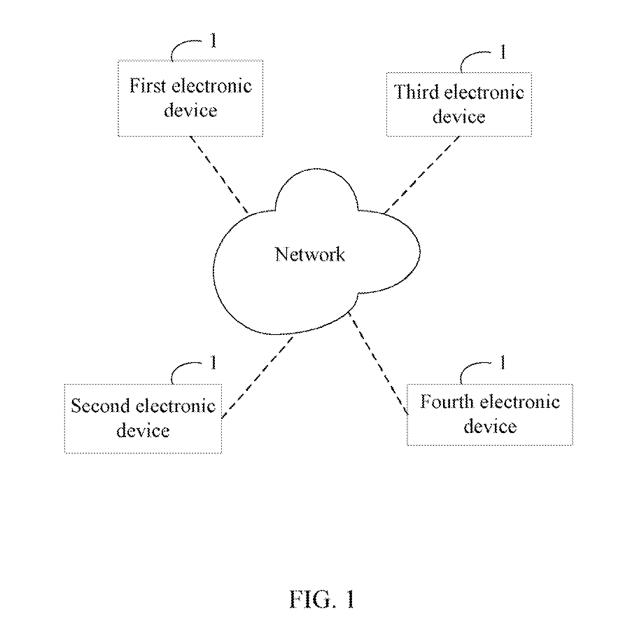

FIG. 1 is an applied schematic view of a data processing system in accordance with an exemplary embodiment. The data processing system is applied among several electronic devices 1 which are connected each other via network, such as LAN or WLAN. The several electronic devices 1 can interact on the network and transmit data to each other. The electronic device 1 may be a computer or a mobile phone. All the several electronic devices 1 perform the data processing system.

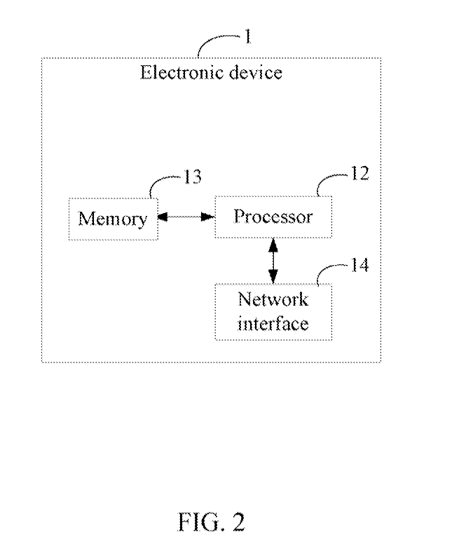

FIG. 2 is a block diagram of an electronic device performing the data processing system of FIG. 1. The electronic device 1 includes a processor 12, a memory 13, and a network interface 14. The processor 12 controls the electronic device 1 to work. The memory 13 stores files, such as photos. The network interface 14 is utilized to connect the electronic device 1 to the network. When the electronic device 1 is a computer, the network interface 14 connects the electronic device 1 to the network by wire. When the electronic device 1 is a mobile phone, the network interface 14 connects the electronic device 1 to the network wirelessly.

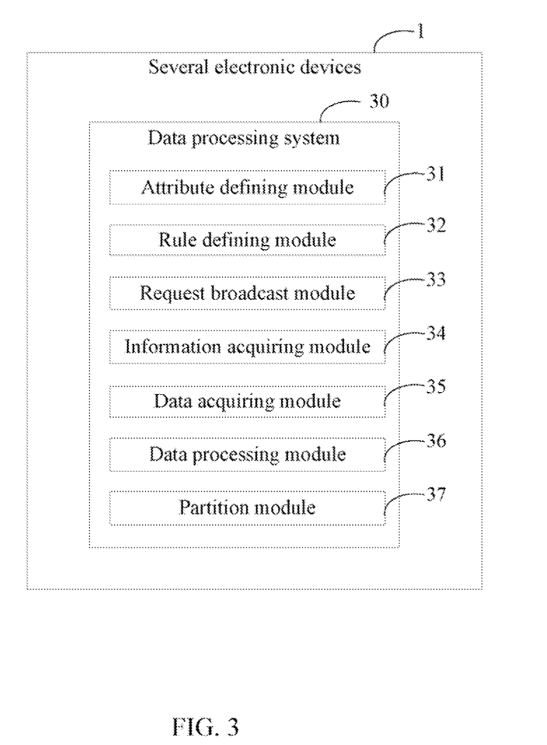

As shown in FIG. 3, the data processing system 30 further includes an attribute defining module 31, a rule defining module 32, a request broadcast module 33, an information acquiring module 34, a data acquiring module 35, and a data processing module 36, all of which are collection of software instructions and executed by at least one processors 12 from all the several electronic devices 1.

The attribute defining module 31 defines an attribute of each electronic device 1 in response to user input. The attribute includes personal and public. For example, a server is connected to some computers and an administrator of the server arranges the attribute of each computer. For example, a first computer is defined as a personal attribute and a second computer is defined as a public attribute.

The rule defining module 32 defines an attribute of each file stored in the electronic device according to the attribute of the electronic device and names each file according to the attribute of each file. When the attribute of the electronic device 1 is defined as personal, the electronic device 1 is assigned an identified code, and the files stored in the electronic device 1 may be a private attribute or a shared attribute. When the attribute of the electronic device 1 is defined as public, the electronic device 1 is not assigned an identified code, and all the files stored in the electronic device 1 are a shared attribute.

In the embodiment, each file is added a suffix name in accordance with the attribute, for example, a private file includes a suffix name of “sss” and a shared file includes a suffix name of “ggg”. In another embodiment, the data processing system 30 further includes a partition module 37, instead of the rule defining module 32. The partition module 37 divides the memory 13 into a private partition and a shared partition according to the attribute of the electronic device 1. For example, when the attribute of the electronic device 1 is personal, the memory 13 is divided into the private partition and the shared partition; and when the attribute of the electronic device 1 is public, the memory 13 is the shared partition. The private partition stores private files and the shared partition stores shared files.

When one of the interacting electronic devices (hereafter, a request electronic device) performs a task, such as making an album or writing a story, the request broadcast module 33 broadcasts a request to all the other interacting electronic devices which are connected to the same network with the request electronic device 1. The request contains the attribute of the request electronic device 1 and content relative to the task. For example, when the request electronic device 1 makes an album about Hong Kong in response to user input, the request broadcast module 33 broadcasts the request containing the personal electronic device 1 and photos about Hong Kong to all the other interacting electronic devices on the network.

The information acquiring module 34 acquires the attribute of the request electronic device 1 and the content associated with the task in response to the request. For example, the information acquiring module 34 acquires at least one keyword from the content, such as the content containing two keywords of Hong Kong and photo.

The data acquiring module 35 acquires the attribute of each of all the other interacting electronic devices (hereinafter, each interacting electronic device), and acquires data relative to the content from each interacting electronic device according to the attributes of each interacting electronic device and the request electronic device 1. In the embodiment, the data include files. For example, when both the attributes of the request electronic device and the interacting electronic device are personal, the data acquiring module 35 determines whether or not both the request electronic device and the interacting electronic device are legal based on the identified codes. When both the request electronic device and the interacting electronic device are legal, the data acquiring module 35 acquires the data relative to the content from the interacting electronic device, and the data can be private files, shared files, or a combination of the private and the shared files.

When the request electronic device is personal and the interacting electronic device is public, the data acquiring module 35 determines that the request electronic device acquires the shared data relative to the content from the interacting electronic device according to the attributes of the request electronic device and the interacting electronic device. When both the request electronic device and the interacting electronic device are public, the data acquiring module 35 acquires the shared data relative to the content from the interacting electronic device according to the attributes of the request electronic device and the interacting electronic device. When the request electronic device is public and the interacting electronic device is personal, the data acquiring module 35 determines that the request electronic device acquires the shared data relative to the content from the interacting electronic device according to the attributes of the request electronic device and the interacting electronic device.

The data processing module 36 receives the data from each interacting electronic device and acquires data relative to the task from the request electronic device to finish the task. For example, the data processing module 36 receives photos about Hong Kong in the request electronic device and from each interacting electronic device to finish the album about Hong Kong.

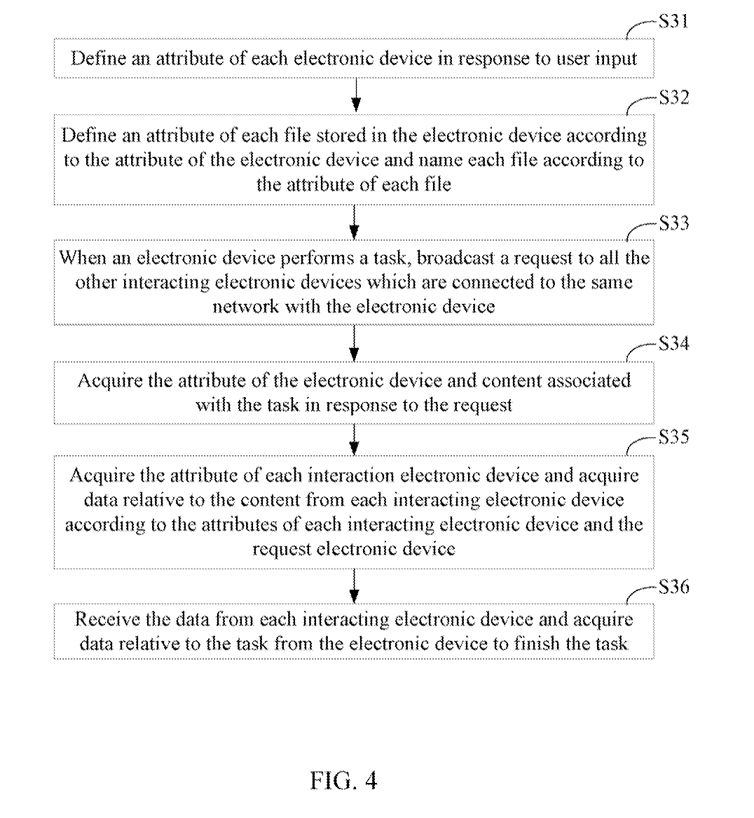

FIG. 4 is a flowchart illustrating a method of processing data adapted for the data processing system of FIG. 1. In step S31, the attribute defining module 31 defines an attribute of each electronic device 1 in response to user input.

In step S32, the rule defining module 32 defines an attribute of each file stored in the electronic device according to the attribute of the electronic device and names each file according to the attribute of each file.

In step S33, when one of the interacting electronic devices (hereafter, a request electronic device) performs a task, the request broadcast module 33 broadcasts a request to all the other interacting electronic devices which are connected to the same network with the request electronic device 1.

In step S34, the information acquiring module 34 acquires the attribute of the request electronic device 1 and the content associated with the task in response to the request.

In step S35, the data acquiring module 35 acquires the attribute of each of all the other interacting electronic devices (hereinafter, each interacting electronic device), and acquires data relative to the content from each interacting electronic device according to the attributes of each interacting electronic device and the request electronic device 1.

In step S36, the data processing module 36 receives the data from each interacting electronic device and acquires data relative to the task from the request electronic device to finish the task.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A data processing system for a plurality of electronic devices, the plurality of electronic devices connected to the same network and each of the plurality of electronic devices storing a plurality of files, the data processing system comprising:
one or more processors; and
a plurality of modules to be executed by the one or more processors, the modules comprising:
a request broadcast module to broadcast a request from one of the plurality of electronic devices to other electronic devices when the electronic device performs a task, wherein the request contains an attribute of the electronic device and content relative to the task;
an information acquiring module to acquire the attribute of the electronic device and the content associated with the task in response to the request;
a data acquiring module to acquire an attribute of each of other electronic devices and acquire files relative to the content from each of other electronic devices according to the attributes of each of other electronic devices and the electronic device; and
a data processing module to receive the files from each of other electronic devices and acquire files relative to the content from the electronic device to finish the task.

2. The data processing system of claim 1, wherein the attribute comprises personal and public, the data processing system further comprises a rule defining module to define an attribute of each file stored in the electronic device according to the attribute of the electronic device and name each file according to the attribute of each file, when the attribute of the electronic device is defined as personal, the electronic device is assigned an identified code, and the files stored in the electronic device may be a private attribute or a shared attribute, and when the attribute of the electronic device is defined as public, the electronic device is not assigned an identified code, and all the files stored in the electronic device are a shared attribute.

3. The data processing system of claim 2, wherein each file is added a suffix name in accordance with the attribute.

4. The data processing system of claim 1, wherein the data processing system further comprises a partition module to divides a memory of the electronic device into a private partition and a shared partition according to the attribute of the electronic device.

5. The data processing system of claim 4, wherein when the attribute of the electronic device is personal, the memory is divided into the private partition and the shared partition; and when the attribute of the electronic device is public, the memory is the shared partition, and the private partition stores private files and the shared partition stores shared files.

6. The data processing system of claim 2, wherein when both the electronic device and one of other electronic devices are personal, the data acquiring module is configured to determine whether or not both the electronic device and the one of other electronic devices are legal based on the identified codes, when both the electronic device and the one of other electronic devices are legal, the data acquiring module is configured to acquire the files relative to the content from the one of other electronic devices, and the files comprises private files and shared files; when the electronic device is personal and the one of other electronic devices is public, the data acquiring module is configured to acquire the shared files relative to the content from the one of other electronic devices according to the attributes of the electronic device and the one of other electronic devices; when both the electronic device and the one of other electronic devices are public, the data acquiring module is configured to acquire the shared files relative to the content from the one of other electronic devices according to the attributes of the electronic device and the one of other electronic devices; when the electronic device is public and the one of other electronic devices is personal, the data acquiring module is configured to acquire the shared files relative to the content from the one of other electronic devices according to the attributes of the electronic device and the one of other electronic devices.

7. A data processing method adapted for a plurality of electronic devices, the plurality of electronic devices connected to the same network and each of the plurality of electronic devices storing a plurality of files, the method comprising:
broadcasting a request from one of the plurality of electronic devices to other electronic devices when the electronic device performs a task, wherein the request contains an attribute of the electronic device and content relative to the task;
acquiring the attribute of the electronic device and the content associated with the task in response to the request;
acquiring an attribute of each of other electronic devices and acquiring files relative to the content from each of other electronic devices according to the attributes of each of other electronic devices and the electronic device; and
receiving the files from each of other electronic devices and acquiring files relative to the content from the electronic device to finish the task.

8. The data processing method of claim 8, wherein the attribute comprises personal and public, the method further comprising:
defining an attribute of each file stored in the electronic device according to the attribute of the electronic device and naming each file according to the attribute of each file, when the attribute of the electronic device is defined as personal, the electronic device is assigned an identified code, and the files stored in the electronic device may be a private attribute or a shared attribute, and when the attribute of the electronic device is defined as public, the electronic device is not assigned an identified code, and all the files stored in the electronic device are a shared attribute.

9. The data processing method of claim 8, wherein each file is added a suffix name in accordance with the attribute.

10. The data processing method of claim 7, further comprising:
dividing a memory of the electronic device into a private partition and a shared partition according to the attribute of the electronic device.

11. The data processing method of claim 10, wherein when the attribute of the electronic device is personal, the memory is divided into the private partition and the shared partition; and when the attribute of the electronic device is public, the memory is the shared partition, and the private partition stores private files and the shared partition stores shared files.

12. The data processing method of claim 8, further comprising:
when both the electronic device and one of other electronic devices are personal, determining whether or not both the electronic device and the one of other electronic devices are legal based on the identified codes;
when both the electronic device and the one of other electronic devices are legal, acquiring the files relative to the content from the one of other electronic devices, wherein the files comprises private files and shared files;
when the electronic device is personal and the one of other electronic devices is public, acquiring the shared files relative to the content from the one of other electronic devices according to the attributes of the electronic device and the one of other electronic devices;
when both the electronic device and the one of other electronic devices are public, acquiring the shared files relative to the content from the one of other electronic devices according to the attributes of the electronic device and the one of other electronic devices; and
when the electronic device is public and the one of other electronic devices is personal, acquiring the shared files relative to the content from the one of other electronic devices according to the attributes of the electronic device and the one of other electronic devices.

13. A computer-readable storage medium encoded with a computer program, the program comprising instructions that when executed by one or more computers cause the one or more computers to perform operations for processing data of a plurality of electronic devices, the plurality of electronic devices connected to the same network, the operations comprising:
broadcasting a request from one of the plurality of electronic devices to other electronic devices when the electronic device performs a task, wherein the request contains an attribute of the electronic device and content relative to the task;
acquiring the attribute of the electronic device and the content associated with the task in response to the request;
acquiring an attribute of each of other electronic devices and acquiring files relative to the content from each of other electronic devices according to the attributes of each of other electronic devices and the electronic device; and
receiving the files from each of other electronic devices and acquiring files relative to the content from the electronic device to finish the task.

14. The computer-readable storage medium encoded with a computer program of claim 13, wherein the attribute comprises personal and public, the operations further comprising:
defining an attribute of each file stored in the electronic device according to the attribute of the electronic device and naming each file according to the attribute of each file, when the attribute of the electronic device is defined as personal, the electronic device is assigned an identified code, and the files stored in the electronic device may be a private attribute or a shared attribute, and when the attribute of the electronic device is defined as public, the electronic device is not assigned an identified code, and all the files stored in the electronic device are a shared attribute.

15. The computer-readable storage medium encoded with a computer program of claim 14, wherein each file is added a suffix name in accordance with the attribute.

16. The computer-readable storage medium encoded with a computer program of claim 13, the operations further comprising:
dividing a memory of the electronic device into a private partition and a shared partition according to the attribute of the electronic device.

17. The computer-readable storage medium encoded with a computer program of claim 16, wherein when the attribute of the electronic device is personal, the memory is divided into the private partition and the shared partition; and when the attribute of the electronic device is public, the memory is the shared partition, and the private partition stores private files and the shared partition stores shared files.

18. The computer-readable storage medium encoded with a computer program of claim 14, the operations further comprising:
when both the electronic device and one of other electronic devices are personal, determining whether or not both the electronic device and the one of other electronic devices are legal based on the identified codes;
when both the electronic device and the one of other electronic devices are legal, acquiring the files relative to the content from the one of other electronic devices, wherein the files comprises private files and shared files;
when the electronic device is personal and the one of other electronic devices is public, acquiring the shared files relative to the content from the one of other electronic devices according to the attributes of the electronic device and the one of other electronic devices;
when both the electronic device and the one of other electronic devices are public, acquiring the shared files relative to the content from the one of other electronic devices according to the attributes of the electronic device and the one of other electronic devices; and
when the electronic device is public and the one of other electronic devices is personal, acquiring the shared files relative to the content from the one of other electronic devices according to the attributes of the electronic device and the one of other electronic devices.
